(19) United States
(12) Patent Application Publication
(10) Pub. No.: US 2020/0077137 A1
(43) Pub. Date: Mar. 5, 2020

(54) VIDEO INTERACTION METHOD AND APPARATUS

(71) Applicant: BEIJING YOUKU TECHNOLOGY CO., LTD., Beijing (CN)

(72) Inventors: Xi Ji, Beijing (CN); Mingzhe Niu, Beijing (CN); Junqiang Xue, Beijing (CN); Yuze Li, Beijing (CN); Shengnan Li, Beijing (CN)

(21) Appl. No.: 16/557,742

(22) Filed: Aug. 30, 2019

(30) Foreign Application Priority Data
Aug. 31, 2018 (CN) 201811014034.0

(51) Int. Cl. H04N 21/431; H04N 21/2343; H04N 21/233; H04N 21/439; H04N 21/4722

(52) U.S. Cl. CPC H04N 21/4316; H04N 21/234336; H04N 21/4722; H04N 21/4394; H04N 21/233

(57) ABSTRACT

A method including obtaining a first interaction content matching an interaction triggering event when the interaction triggering event is detected during play of a video; and displaying or playing the first interaction content. When the interaction triggering event is detected during play of the video, the first interaction content matching the interaction triggering event is obtained, and the first interaction content is displayed and/or played. The video interaction method and apparatus according to example embodiments of the present disclosure interact with the user when the user watches the video, accompany the user to watch the video, and timely answer the user's questions, thereby greatly improving the user's experience in watching the video.

### CROSS REFERENCE TO RELATED PATENT APPLICATIONS

This application claims priority to and is a continuation of Chinese Patent Application No. 201811014034.0, filed on 31 Aug. 2018 and entitled “VIDEO INTERACTION METHOD AND APPARATUS,” which is incorporated herein by reference in its entirety.

### TECHNICAL FIELD

The present disclosure relates to the field of information technologies, and, more particular, to video interaction methods and video interaction apparatuses.

### BACKGROUND

Watching video has now become the first choice for most people during leisure time, but many times people watch the video alone. In this case, a user cannot perform communication and interaction during a video viewing process, so that the video viewing process is monotonous and cannot bring a pleasant experience to the user. In addition, content of a video that the user clicks sometimes may not be the area of the user's expertise. Alternatively, there could be a large amount of latest information in the video. These would cause much confusion and trouble to the user when the user watches the video.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

Video interaction methods and apparatuses are proposed in the present disclosure.

According to an example embodiment of the present disclosure, a video interaction method is provided, which is applied in a terminal. The method includes:

obtaining a first interaction content matching an interaction triggering event when the interaction triggering event is detected during play of a video; and

displaying and/or playing the first interaction content.

In an example implementation, the interaction triggering event includes one or more of the following: a user state, a user input, play to a preset video time point, and play to a video content matching a user tag.

In an example implementation, obtaining a first interaction content matching an interaction triggering event when the interaction triggering event is detected includes:

sending a request indicating the interaction triggering event to a server when the interaction triggering event is detected; and

receiving the first interaction content matching the interaction triggering event from the server.

In an example implementation, the method further includes:

determining the interaction triggering event according to settings of the user.

In an example implementation, displaying and/or playing the first interaction content includes:

selecting a second interaction content from the first interaction content according to the user tag; and

displaying and/or playing the second interaction content.

In an example implementation, the first interaction content includes one or more of the following: a text, an audio, a video, an animated picture such as a GIF, and a picture.

In an example implementation, displaying and/or playing the first interaction content includes:

determining a style of the display and/or play according to the user tag; and

displaying or playing the first interaction content according to the determined style of the display and/or play.

In an example implementation, displaying and/or playing the second interaction content includes:

determining a style of the display and/or play according to the user tag; and

displaying and/or playing the second interaction content according to the determined style of the display or play.

According to an example embodiment of the present disclosure, a video interaction method applied to a server is provided, including:

receiving a request sent by a terminal, the request indicating an interaction triggering event detected by the terminal during play of a video;

determining the first interaction content matching the interaction triggering event; and

sending the first interaction content to the terminal so that the terminal displays and/or plays the first interaction content.

In an example implementation, the interaction triggering event includes one or more of the following: a user state, a user input, play to a preset video time point, and play to a video content matching a user tag.

In an example implementation, the method further includes:

determining the interaction triggering event according to settings of the user.

In an example implementation, sending the first interaction content to the terminal so that the terminal displays and/or plays the first interaction content includes:

selecting a second interaction content from the first interaction content according to the user tag; and

sending the second interaction content to the terminal so that the terminal displays and/or plays the second interaction content.

In an example implementation, the first interaction content includes one or more of the following: a text, an audio, a video, an animated picture, and a picture.

In an example implementation, sending the first interaction content to the terminal so that the terminal displays and/or plays the first interaction content includes:

determining a style of the display and/or play according to the user tag; and

sending the first interaction content and the style of the display and/or play to the terminal so that the terminal displays and/or plays the first interaction content according to the style of the display and/or play.

In an example implementation, sending the second interaction content to the terminal so that the terminal displays and/or plays the second interaction content includes:

determining a style of the display and/or play according to the user tag; and

sending the second interaction content and the style of the display or play to the terminal so that the terminal displays and/or plays the second interaction content according to the style of the display and/or play.

According to an example embodiment of the present disclosure, a video interaction apparatus is provided, including:

a first interaction content acquisition module configured to obtain a first interaction content matching an interaction triggering event when the interaction triggering event is detected during play of a video; and

a first interaction content presentation module configured to display and/or play the first interaction content.

In an example implementation, the interaction triggering event includes one or more of the following: a user state, a user input, play to a preset video time point, and play to a video content matching a user tag.

In an example implementation, the first interaction content acquisition module includes:

a first interaction content requesting unit configured to send a request indicating the interaction triggering event to a server when the interaction triggering event is detected; and

a first interaction content receiving unit configured to receive the first interaction content matching the interaction triggering event from the server.

In an example implementation, the apparatus further includes:

a first interaction triggering event determination module configured to determine the interaction triggering event according to settings of the user.

In an example implementation, the first interaction content presentation module includes:

a first selecting unit configured to select a second interaction content from the first interaction content according to the user tag; and

a second interaction content presentation unit configured to display and/or play the second interaction content.

In an example implementation, the first interaction content includes one or more of the following: a text, an audio, a video, an animated picture, and a picture.

In an example implementation, the first interaction content presentation module includes:

a first presentation style determination unit configured to determine a style of the display and/or play according to the user tag; and

a first interaction content presentation unit configured to display or play the first interaction content according to the determined style of the display and/or play.

In an example implementation, the second interaction content presentation unit includes:

a second presentation style determination sub-unit configured to determine a style of the display and/or play according to the user tag; and

a second interaction content presentation sub-unit configured to display and/or play the second interaction content according to the determined style of the display or play.

According to an example embodiment of the present disclosure, a video interaction apparatus is provided, including:

a request receiving module configured to receive a request sent by a terminal, the request indicating an interaction triggering event detected by the terminal during play of a video;

a first interaction content determination module configured to determine the first interaction content matching the interaction triggering event; and

a first interaction content sending module configured to send the first interaction content to the terminal so that the terminal displays and/or plays the first interaction content.

In an example implementation, the interaction triggering event includes one or more of the following: a user state, a user input, play to a preset video time point, and play to a video content matching a user tag.

In an example implementation, the apparatus further includes:

a second interaction triggering event determination module configured to determine the interaction triggering event according to settings of the user.

In an example implementation, the first interaction content sending module includes:

a second selecting unit configured to select a second interaction content from the first interaction content according to the user tag; and

a second interaction content sending unit configured to send the second interaction content to the terminal so that the terminal displays and/or plays the second interaction content.

In an example implementation, the first interaction content includes one or more of the following: a text, an audio, a video, an animated picture, and a picture.

In an example implementation, the first interaction content sending module includes:

a third presentation style determination unit configured to determine a style of the display and/or play according to the user tag; and

a first interaction content sending unit configured to send the first interaction content and the style of the display and/or play to the terminal so that the terminal displays and/or plays the first interaction content according to the style of the display and/or play.

In an example implementation, the second interaction content sending unit includes:

a fourth presentation style determination sub-unit configured to determine a style of the display and/or play according to the user tag; and

a second interaction content sending sub-unit configured to send the second interaction content and the style of the display or play to the terminal so that the terminal displays and/or plays the second interaction content according to the style of the display and/or play.

According to an example embodiment of the present disclosure, a video interaction apparatus is provided, including: a processor, a memory configured to store processor executable instructions, wherein the processor is configured to perform the above method.

According to an example embodiment of the present disclosure, a non-volatile computer readable medium having computer-readable instructions stored thereon is provided, wherein when executed by a processor, the computer-readable instructions implement the above method.

When the interaction triggering event is detected during play of the video, the first interaction content matching the interaction triggering event is obtained, and the first interaction content is displayed and/or played. The video interaction methods and apparatuses according to example embodiments of the present disclosure interact with the user when the user watches the video, accompany the user to watch the video, and timely answer the user's questions, thereby greatly improving the user's experience in watching the video.

Other features and aspects of the present disclosure will become more apparent according to detailed description of example embodiments with reference to accompanying drawings.

### BRIEF DESCRIPTION OF THE DRAWINGS

In order to illustrate the technical solutions in the example embodiments of the present disclosure more clearly, the following briefly describes the accompanying drawings which aid in describing the example embodiments. Apparently, the accompanying drawings merely show some of the example embodiments of the present disclosure, and persons of ordinary skill in the art may derive other drawings from these accompanying drawings without creative efforts.

FIG. 1 is a flowchart of a video interaction method according to an example embodiment of the present disclosure;

FIG. 2 is a flowchart of a video interaction method according to an example embodiment of the present disclosure;

FIG. 3 is a schematic diagram of a setting interface for an interaction triggering event according to an example embodiment of the present disclosure;

FIG. 4 is a flowchart of step S11 according to an example embodiment of the present disclosure;

FIG. 5 is a flowchart of step S12 according to an example embodiment of the present disclosure;

FIG. 6 is a flowchart of step S12 according to an example embodiment of the present disclosure;

FIG. 7 is a flowchart of step S124 according to an example embodiment of the present disclosure;

FIG. 8 is a flowchart of a video interaction method according to an example embodiment of the present disclosure;

FIG. 9 is a flowchart of a video interaction method according to an example embodiment of the present disclosure;

FIG. 10 is a flowchart of step S23 according to an example embodiment of the present disclosure;

FIG. 11 is a flowchart of step S23 according to an example embodiment of the present disclosure;

FIG. 12 is a flowchart of step S234 according to an example embodiment of the present disclosure;

FIG. 13 is a block diagram of a video interaction apparatus according to an example embodiment of the present disclosure;

FIG. 14 is a block diagram of a video interaction apparatus according to an example embodiment of the present disclosure;

FIG. 15 is a block diagram of a video interaction apparatus according to an example embodiment of the present disclosure;

FIG. 16 is a block diagram of a video interaction apparatus according to an example embodiment of the present disclosure;

FIG. 17 is a block diagram of a first interaction content sending module 23 according to an example embodiment of the present disclosure;

FIG. 18 is a block diagram of a video interaction apparatus according to an example embodiment of the present disclosure;

FIG. 19 is a block diagram of a video interaction apparatus according to an example embodiment of the present disclosure; and

FIG. 20 is a block diagram of a video interaction apparatus according to an example embodiment of the present disclosure.

### DETAILED DESCRIPTION

Various example embodiments, features, and aspects of the present disclosure will be illustrated in detail below with reference to the accompanying drawings. Identical reference numerals in the accompanying drawings indicate identical or similar elements. Various aspects of the example embodiments are shown in the accompanying drawings; however, the accompanying drawings are not necessarily drawn proportionally, unless otherwise specified.

Here, the term “exemplary” means “being used as an example, or an example embodiment, or being illustrative”. Here, any example embodiment illustrated as “exemplary” should not be explained as being superior to or better than other example embodiments.

In addition, numerous specific details are provided in the following example implementations to better illustrate the present disclosure. Those skilled in the art should understand that the present disclosure may still be implemented without some specific details. In some examples, methods, measures, elements and circuits well-known to those skilled in the art are not described in detail, thus highlighting the theme of the present disclosure.

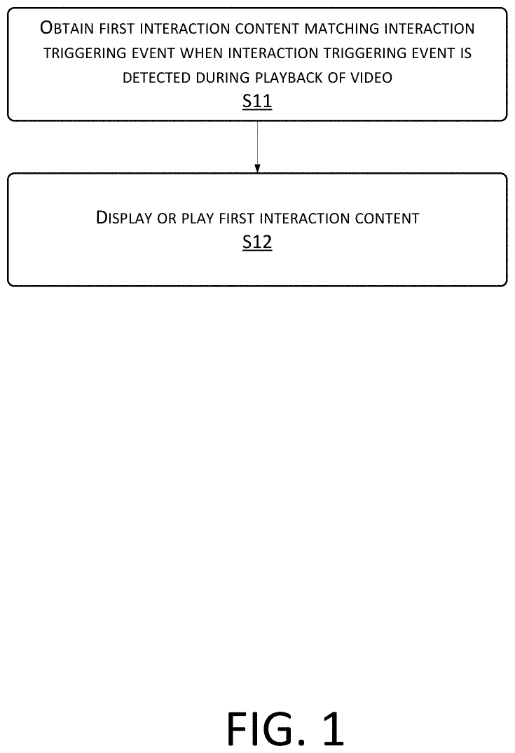

FIG. 1 is a flowchart of a video interaction method according to an example embodiment of the present disclosure. The method is applicable to a terminal, and the terminal may be a mobile terminal, a computer, a PDA, and so on. As shown in FIG. 1, the method may include the following steps.

In step S11, a first interaction content matching an interaction triggering event is obtained when the interaction triggering event is detected during play of a video.

The interaction triggering event may refer to an event that triggers an interaction. The interaction triggering event may be preset by the terminal, or preset by a server and then downloaded and stored by the terminal, or may be a prompt or a question of a user during the video viewing process. The interaction triggering event is not limited in the present disclosure, and events that require interactions actively or passively in the process of the user viewing play of the video may all be considered as interaction triggering events.

The first interaction content matching the interaction triggering event may be a first interaction content preset by the terminal as matching the interaction triggering event, or preset by a server and then downloaded and stored by the terminal, or may be a real-time response to the interaction triggering event. The real-time response may be obtained by searching a preset database, and the preset database may include correspondences of various questions and various replies. For example, a lexicon or the like is preset, and the terminal may search in the lexicon to obtain a reply corresponding to the interaction triggering event as the first interaction content matching the interaction triggering event. The first interaction content may be a content that may be displayed and/or played in any form, which is not limited in the present disclosure.

The user who wants to watch a video may select the video to watch through an APP or a webpage on the terminal. After the user clicks on the selected video, the terminal may activate an interaction (accompanying) assistant when detecting that the video starts to be played, and an interaction assistant icon may be displayed in any area of a video play interface. The user may choose to hide the interaction assistant icon, or the user may turn off the interaction assistant icon at any moment during the video play to reject the interaction.

For example, after the user clicks on the selected video, the terminal may activate the interaction assistant without displaying it when detecting that the video starts to be played, and displays the interaction assistant icon only when the interaction triggering event is detected. The display time and display area of the interaction assistant icon are not limited in the present disclosure, as long as the purpose of interaction may be achieved and the user's watching the video is affected as little as possible.

The interaction assistant icon may be determined according to the user's preference. For example, the user likes cartoons, and the interaction assistant icon may be determined as a cartoon image. Alternatively, the interaction assistant icon may be determined according to a type of a video viewed by the user. For example, the video watched by the user is a television series set in the Qing dynasty, and the interaction assistant icon may be determined as a character in the television series set in the Qing dynasty. The form of the interaction assistant icon is not limited in the present disclosure.

During the video play process, the terminal may detect whether there is an interaction triggering event, and when the interaction triggering event is detected, the first interaction content matching the interaction triggering event may be obtained.

When detecting the interaction triggering event, the terminal may search for a first interaction content matching the interaction triggering event as preset or search a preset database to obtain the first interaction content matching the interaction triggering event. For example, an answer matching the user's voice is obtained by searching the database.

For example, during the video play process, the terminal detects that the interaction triggering event is a frequent dragging of a play progress bar, and the terminal may search for a first interaction content matching the interaction triggering event as preset, and obtain that the first interaction content matching the interaction triggering event is prompt information: “Are you not interested in this video?”.

Or, during the video play process, the terminal detects that the interaction triggering event is the user leaving, and the terminal may search the preset database to obtain a conversation content matching the user leaving as the first interaction content, for example, it may be “Master, do I need to pause?”. Or, the terminal may also obtain the first interaction content matching the video type and the user state. For example, if the video type is a television series set in the Qing dynasty, the terminal may obtain the first interaction content matching the user leaving as “Young Mistress, do I need to pause?”.

In step S12, the first interaction content is displayed or played.

The terminal may display or play the obtained first interaction content in an area of the video interface. For example, the first interaction content obtained by the terminal is “Young Mistress, do I need to pause?”. The terminal may play “Young Mistress, do I need to pause?” in a form of a voice. The terminal may also select a sound, for example, select the sound of the user's idol. Or, the terminal may display “Young Mistress, do I need to pause?” in a form of a text. The terminal may also set the background of the displayed text to match the video type, for example, set the background of the displayed text to the classical style.

The above is only an example of displaying or playing the first interaction content, which is not limited in the present disclosure, as long as the display or play may achieve good interaction with the user.

It should be noted that, when multiple interaction triggering events are detected, multiple first interaction contents matching the multiple interaction triggering events may be displayed and/or played, and the multiple first interaction contents may be separated apart in a time sequence to avoid mutual interference.

When the interaction triggering event is detected during play of the video, the first interaction content matching the interaction triggering event is obtained, and the first interaction content is displayed or played. The video interaction method according to example embodiments of the present disclosure may interact with the user when the user watches the video, may accompany the user to watch the video, and may timely answer the user's questions, thereby greatly improving the user's experience in watching the video.

In an example implementation, the interaction triggering event may include one or more of the following: a user state, a user input, play to a preset video time point, and play to a video content matching a user tag.

The user state may refer to a user's mental state and physical state, such as the user feeling sad and the user leaving, or may be a user operating state, such as dragging the mouse frequently, fast forwarding, and fast rewinding. The user's mental state and physical state may be determined by taking an image of the user by a camera for image analysis, and the user's operating state may be determined by monitoring operations of a touch screen, a mouse, a keyboard, and the like. The terminal may be preset with a user state as an interaction triggering event, such as the user feeling sad, happy, the user leaving, frequently dragging the mouse, fast forwarding, rewinding, etc. Once the user state detected by the terminal is matching the preset user state, the terminal determines that the occurrence of the interaction triggering event is detected, and step S11 may be performed.

The user input may refer to user input detected during video play, and may include any form of input such as voice input or text input, e.g., a question or indication input by the user through voice or keyboard during video play. For the voice input, the terminal device may collect a sound signal through a microphone, perform voice analysis on the collected sound signal, and obtain voice information input by the user. The terminal may provide an interface for receiving the user input, such as an input box and a voice input button, and may take the reception of the input text or voice information as the occurrence of an interaction triggering event, and step S11 may be performed.

There may be one or more preset video time points in each video, and the terminal or the server may set an identifier for each preset video time point. The terminal may determine whether the video is played to the preset video time point by monitoring the play progress. Once the play progress reaches the preset video time point, it may be determined that the interaction triggering event occurs, and step S11 may be performed.

The user tag may represent the user's attributes, for example, may include basic information of the user, interests, historical information, actors of interest, and the like. The video content matching the user tag may refer to a video content matching any one or more of the user tags. For example, the actors of interest of the user appear in the video. The entire video may be divided into a plurality of video segments in advance, and each video segment is set with a tag, such as an actor name, a gun battle, a climax, sadness, and a punchline, according to the content of each video segment. According to the matching degree between the user tag and the video segment tag (for example, how many tags are consistent or similar), it is judged whether the video segment currently played is a video content matching the user tag, and if so, the occurrence of an interaction triggering event may be determined, and step S11 may be performed.

For the first interaction content matching the interaction triggering event, the terminal or the server may preset the first interaction content matching the interaction triggering event, for example, preset a first interaction content matching the user state, and preset a first interaction content matching play to the preset video time point. The terminal may previously download the first interaction content matching the interaction triggering event preset by the server.

For example, for a user state such as happy and sad, the corresponding first interaction content may include interaction information in a dialogue form, such as “Too sad to look at it!”. For the user state of fast forwarding, the corresponding first interaction content may include redirection prompt information: “Not interested? Click here to see others!”. When the video is played to the preset video time point, the first interaction content may be an introduction text, prompt information, and the like related to the screen content or the plot at the time point, for example, “Surprise alert, unsuitable for a timid”. When the video is played to the video content matching the user tag, the first interaction content may be an introduction text related to the video content, prompt information, a recommendation of other related multimedia contents, and the like.

Alternatively, the terminal may also respond in real time to the interaction triggering event. The real-time response is the first interaction content matching the interaction triggering event, for example, a real-time response to the user's voice or text input, or a real-time response to the video content matching the user tag. For example, the terminal may analyze the received text information or voice information, obtain a keyword or semantic information, and search for a matched reply content in the database according to the keyword or semantic information to serve as the first interaction content.

In an example implementation, the first interaction content may include one or more of the following: a text, an audio, a video, an animated picture, and a picture.

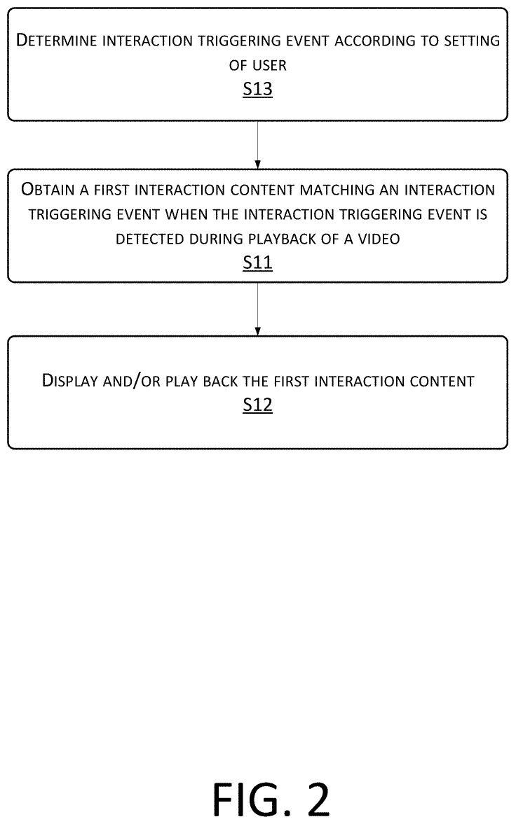

FIG. 2 is a flowchart of a video interaction method according to an example embodiment of the present disclosure. As shown in FIG. 2, in an example implementation, the method may further include the following step.

In step S13, the interaction triggering event is determined according to a setting of the user.

The terminal may acquire the settings of the user for the interaction triggering event, and determine the interaction triggering event according to the setting of the user.

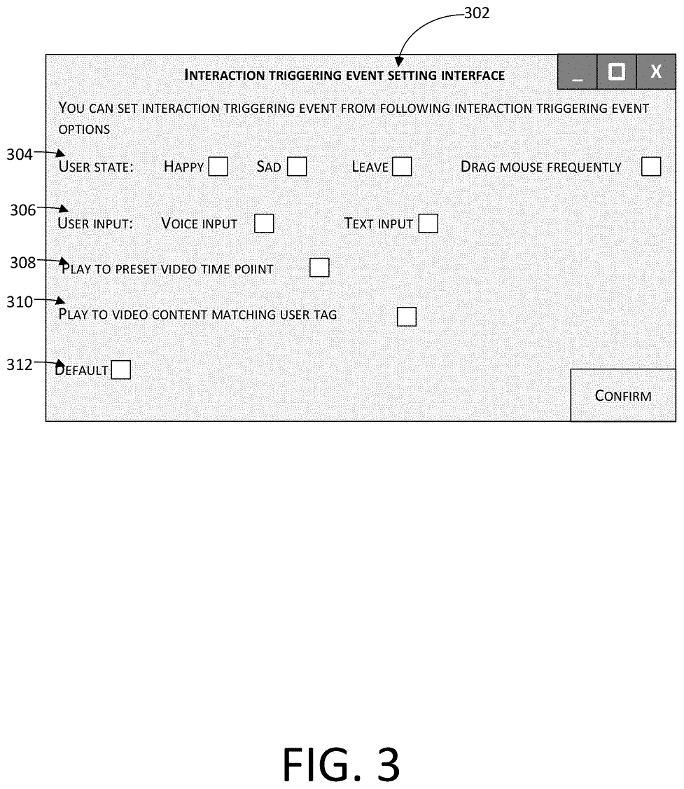

In an example, the user may set the interaction triggering event in an interaction triggering event setting interface as shown in FIG. 3, and the user clicks the interaction assistant icon to enter the interaction triggering event setting interface 302. The interaction triggering event setting interface 302 includes interaction triggering event options. As shown in FIG. 3, the interaction triggering event may include one or more of the following options: a user state 304, a user input 306, play to a preset video time point 308, and play to a video content matching a user tag 310.

The user state 304 includes options such as happy, sad, leave, drag mouse frequently.

The user input 306 includes options such as voice input or text input.

The user implements the setting of the interaction triggering event by selecting the interaction triggering event option. After finishing selection, the user may click for confirmation, and the terminal may detect the setting of the interaction triggering event performed by the user in the interaction triggering event setting interface, and may determine the interaction triggering event of the user according to the settings of the user. For example, if the user only selects user voice, the terminal may determine that the interaction triggering event of the user is user voice. If the user selects play to the preset time point and sadness for the user state, the terminal may determine that interaction triggering conditions of the user are play to the preset time point and the user feeling sad. The terminal may also bind an identifier of the user to the interaction triggering event for storage.

Alternatively, the user may directly select the default 312 settings in the interaction triggering event setting interface, and the terminal may determine that the interaction triggering event of the user is all interaction triggering events in the interaction triggering event options.

For example, when the user watches the video, the interaction triggering event bound to the user may be found according to the identifier of the user, and the terminal may learn about the interaction triggering event bound to the user. During the video play, the terminal may compare the collected user state, the user input, the monitored video time point and video content with the interaction triggering event bound to the user, thereby detecting whether an interaction triggering event occurs.

It should be noted that when the terminal detects the interaction triggering event, a camera of the terminal may be started only when the user state is included in the interaction triggering event set by the user. For the setting of the interaction triggering event, the user may set the interaction triggering event or modify the interaction triggering event at any moment of the video play, which is not limited in the present disclosure.

The interaction triggering event options may be preset by the terminal or the server. For example, the video time point may be preset as an interaction triggering event option according to the video content, and the preset video time point may be a video climax point, a time point when a word or statement that is difficult to be understood appears, and the like. Alternatively, the video content matching the user state, the user voice, and the user tag may be preset as an interaction triggering event option. For example, the interaction triggering event options may include the user feeling sad, the user feeling happy, the user standing up, and the user asking a question through a voice, and a video content matching the user's interests, etc. Alternatively, a periodic interaction may be preset as an interaction triggering event option. The interaction triggering event options are not limited in the present disclosure.

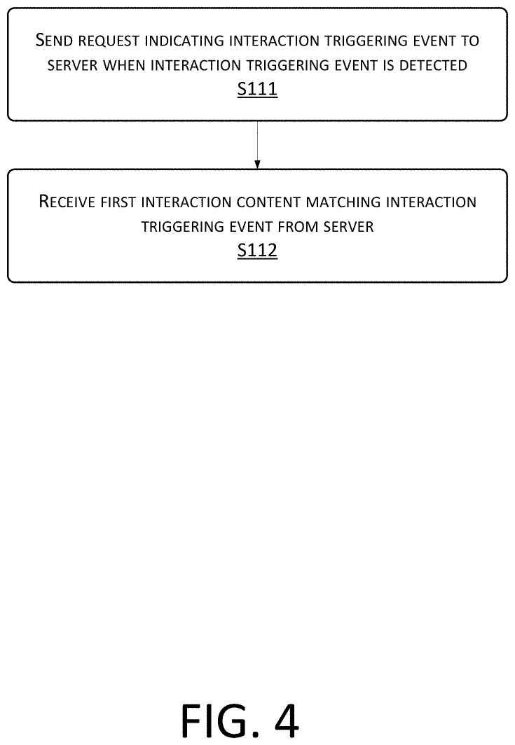

FIG. 4 is a flowchart of step S11 according to an example embodiment of the present disclosure. As shown in FIG. 4, in an example implementation, step S11 may include the following steps.

In step S111, a request indicating the interaction triggering event is sent to a server when the interaction triggering event is detected.

The terminal may detect in real time or periodically whether an interaction triggering event occurs. When the interaction triggering event is detected, a request may be sent to the server, and the request may indicate the interaction triggering event. For example, the request may include an identifier or description information of the interaction triggering event.

In step S112, the first interaction content matching the interaction triggering event is received from the server.

The server may search for a first interaction content matching the interaction triggering event as preset or search a preset database to determine the first interaction content matching the interaction triggering event. The server then sends the first interaction content to the terminal, and the terminal may receive the first interaction content matching the interaction triggering event from the server.

For example, the interaction triggering event set by the user may include the user voice, and when the terminal detects the user voice, for example, detects “What does eagle's eye and wolf s look mean”, the terminal may send a request to the server, and the request indicates that the interaction triggering event is “What does eagle's eye and wolf s look mean”. When the server receives the request, it may search the database and determine that a reply “It describes a cruel person having sharp eyes” matches “What does eagle's eye and wolf s look mean”. The reply may be returned to the terminal, and the terminal receives the first interaction content matching the interaction triggering event, i.e., “It describes a cruel person having sharp eyes”. The terminal may display or play “It describes a cruel person having sharp eyes”.

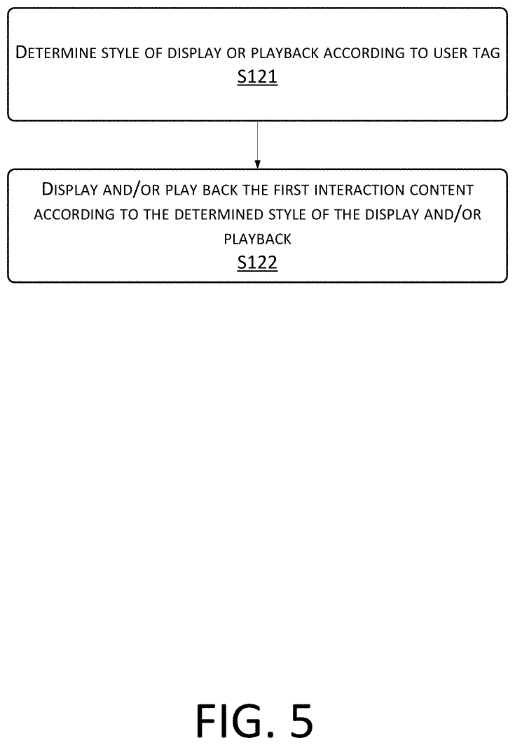

FIG. 5 is a flowchart of step S12 according to an example embodiment of the present disclosure. As shown in FIG. 5, in an example implementation, step S12 may include the following steps.

In step S121, a style of the display or play is determined according to the user tag.

The terminal may acquire the user tags, and determine the style of the display or play according to the acquired user tags. For example, the terminal may determine the style of the display or play according to one or more tags in the user tags. For example, the user tags include gender: female, age: 25, hobbies: cartoon and travel, idol: Hayao Miyazaki, favorite video: City of Sky, and constellation: Sagittarius. From the user tags, the terminal may determine that a plurality of the tags of the user are related to the cartoon, and the terminal may determine that the style of the display and/or play is a cartoon style.

The above is only an example of determining the style of the display and/or play according to the user tags. For example, the style of the display and/or play may be determined according to the gender in the user tags, which is not limited in the present disclosure.

In step S122, the first interaction content is displayed and/or played according to the determined style of the display and/or play.

The terminal may determine the background, font, color, and the like of the display or determine the sound, tone, and the like of the play according to the determined style of the display and/or play.

For example, the above-determined style of the display and/or play is determined as a cartoon style, and the terminal may set the display background as a cartoon picture according to the determined style of the display and/or play, or add a cartoon picture or cartoon GIF to the first interaction content, and may set the sound to the sound of a cartoon character during play.

The terminal may preset a correspondence between the style and a display template, and according to the style, invoke the corresponding display template for displaying and/or playing. The display template may include a background, a font, a color, etc., or a determined sound, a tone, and the like.

By determining the style of the display and/or play based on the user tags, the user experience during the interaction may be improved.

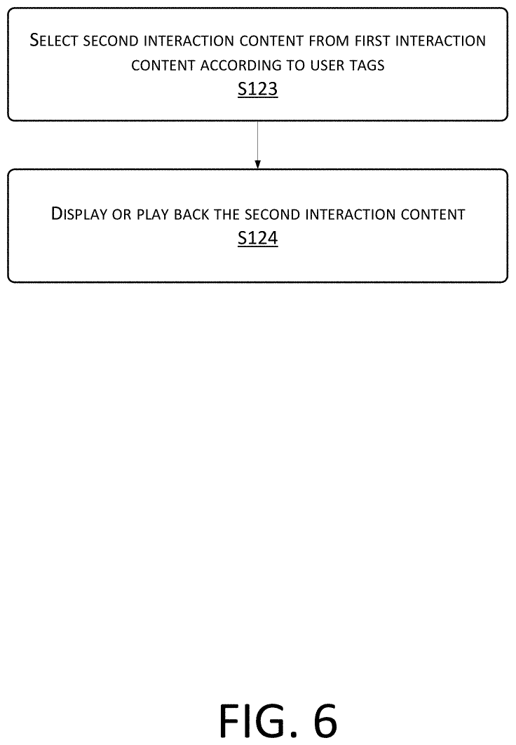

FIG. 6 is a flowchart of step S12 according to an example embodiment of the present disclosure. As shown in FIG. 6, in an example implementation, step S12 may further include the following steps.

In step S123, a second interaction content is selected from the first interaction content according to the user tag.

The terminal may select the second interaction content from the first interaction content according to the user tag. The second interaction content may also have a tag, and the selecting may be performed according to the degree of matching between the user tag and the tag of the second interaction content. For example, a second interaction content matching one or more of the user tags may be selected from the first interaction content, or an interaction content matching one or more of the user tags may be screened out from the first interaction content, thereby selecting the second interaction content.

The second interaction content may include one or more of the following: a text, an audio, a video, an animated picture, and a picture.

In step S124, the second interaction content is displayed or played.

The terminal may display and/or play the second interaction content.

In an example, if the interaction triggering event is play to a preset video time point, and the video the user clicks on to watch is “Romance of the Three Kingdoms”. During the video play, the terminal detects the preset video time point by monitoring the video play progress. At this time, the video picture includes Tsao Tsao's words as “Great wisdom has the look of folly”. The terminal may search for the identifier corresponding to the preset video time point, and may find a matched first interaction content according to the preset video time point identifier, i.e., “Tsao Tsao (155-220 A.D.), whose courtesy name is Meng De, was born in Qiao County of Pei (now Bozhou city in Anhui province). He was an outstanding statesman, strategist, litterateur and calligrapher at the late Eastern Han Dynasty, and was the founder of the Tsao Wei regime in the Three Kingdoms”, and “Great wisdom has the look of folly, this sentence means that a man of great wisdom looks dull”. The terminal may directly display or play the first interaction content, and may further select the second interaction content from the first interaction content according to the user tags. The terminal acquires that a historical expert tag is included in the user tags, and may select the second interaction content from the first interaction content, i.e., “Great wisdom has the look of folly, this sentence means that a man of great wisdom looks dull”. The terminal may display or play the second interaction content “Great wisdom has the look of folly, this sentence means that a man of great wisdom looks dull”.

The first interactive content is filtered according to the user tags, and the interaction content may be dynamically adjusted according to the user tags, which may ensure that the interaction with the user is more effective, and may also avoid unnecessary interruption to the user and improve the user experience in watching the video.

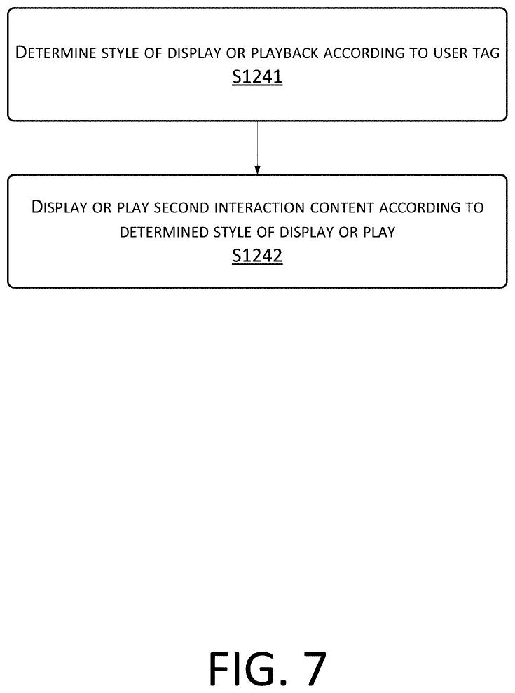

FIG. 7 is a flowchart of step S124 according to an example embodiment of the present disclosure. As shown in FIG. 7, in an example implementation, step S124 may include the following steps.

In step S1241, a style of the display or play is determined according to the user tag.

In step S1242, the second interaction content is displayed or played according to the determined style of the display or play.

For the example implementation processes of the step S1241 and the step S1242, reference may be made to the example implementation processes of the above step S121 and step S122, and details are not elaborated here again.

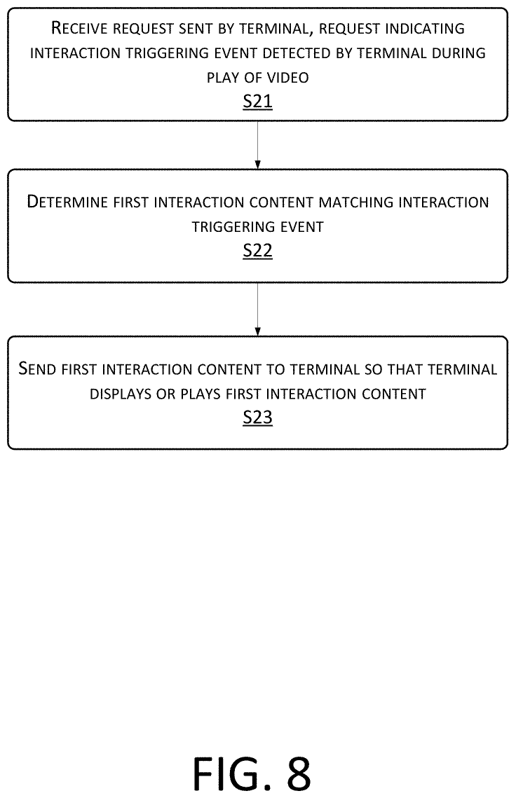

FIG. 8 is a flowchart of a video interaction method according to an example embodiment of the present disclosure. As shown in FIG. 8, the method is applicable to a server, and may include the following steps.

In step S21, a request sent by a terminal is received, the request indicating an interaction triggering event detected by the terminal during play of a video.

When the terminal detects an interaction triggering event during the video play, the terminal may send a request to the server, and the request may indicate the interaction triggering event received during the video play. The server may receive the request sent by the terminal. For example, the request may include an identifier or description information of the interaction triggering event.

In step S22, the first interaction content matching the interaction triggering event is determined.

After receiving the request sent by the terminal, the server may acquire the interaction triggering event indicated by the request. The server may search for a first interaction content matching the interaction triggering event as preset or search a preset database to determine the first interaction content matching the interaction triggering event.

In step S23, the first interaction content is sent to the terminal so that the terminal displays or plays the first interaction content.

The server may send the determined first interaction content to the terminal so that the terminal displays and/or plays the first interaction content.

By receiving the request, the terminal is instructed to determine the first interaction content matching the interaction triggering event when the interaction triggering event is detected during play of the video, and send the first interaction content to the terminal so that the terminal displays or plays the first interaction content. The video interaction method according to example embodiments of the present disclosure may interact with the user when the user watches the video, may accompany the user to watch the video, and may timely answer the user's questions, thereby greatly improving the user's experience in watching the video.

In an example implementation, the first interaction content includes one or more of the following: a text, an audio, a video, an animated picture, and a picture.

In an example implementation, the interaction triggering event may include one or more of the following: a user state, a user input, play to a preset video time point, and play to a video content matching a user tag.

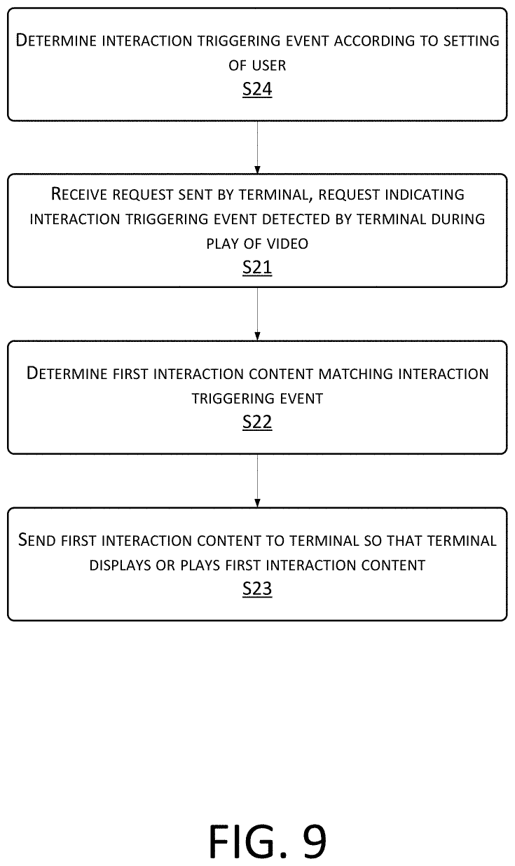

FIG. 9 is a flowchart of a video interaction method according to an example embodiment of the present disclosure. As shown in FIG. 9, in an example implementation, the method may further include the following steps.

In step S24, the interaction triggering event is determined according to a setting of the user.

For example, the user clicks on an interaction assistant icon when watching a video. The terminal detects that the interaction assistant icon is clicked, and sends information requesting an interaction triggering event setting interface to the server. The server may return the interaction triggering event setting interface to enable the terminal to display the interaction triggering event setting interface. The interaction triggering event setting interface includes interaction triggering event options, which may be preset by the server. For the setting of the specific interaction triggering event options, reference may be made to the content in step S13.

The user may select the interaction triggering event options in the interaction triggering event setting interface to implement the setting of the interaction triggering event. After the user finishes the setting, the terminal may send the user's setting to the server, and the server may determine the interaction triggering event according to the received interaction triggering event set by the user and sent by the terminal.

It should be noted that step S24 may be performed before step S21, or step S24 may be performed at any moment during the video play, as long as the user wants to set. After the setting, when the event detected by the terminal is matching the interaction triggering event set by the user, the terminal may then determine that an interaction triggering event is detected.

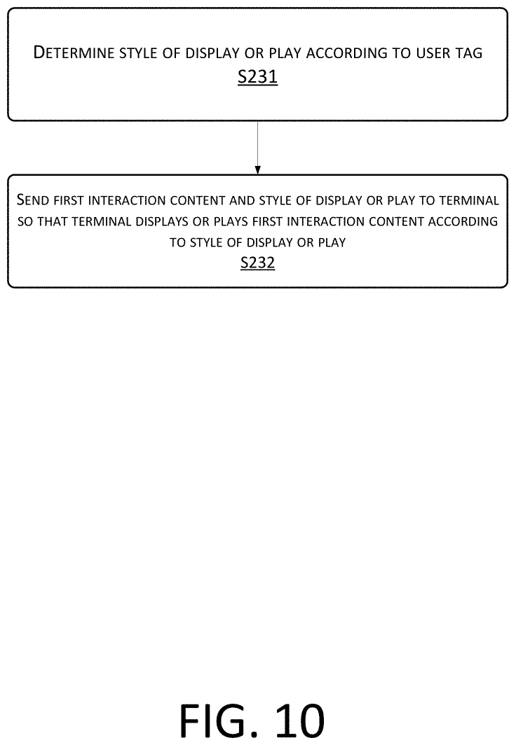

FIG. 10 is a flowchart of step S23 according to an example embodiment of the present disclosure. As shown in FIG. 10, in an example implementation, step S23 may include the following steps.

In step S231, a style of the display or play is determined according to the user tag.

In step S232, the first interaction content and the style of the display or play are sent to the terminal so that the terminal displays and/or plays the first interaction content according to the style of the display or play.

The server may determine the style of the display and/or play according to the user tag, and sends the first interaction content and the style of the display and/or play to the terminal. The style of the display and/or play may be expressed by an identifier or description information of the style, so that the terminal displays and/or plays the first interaction content according to the style of the display and/or play.

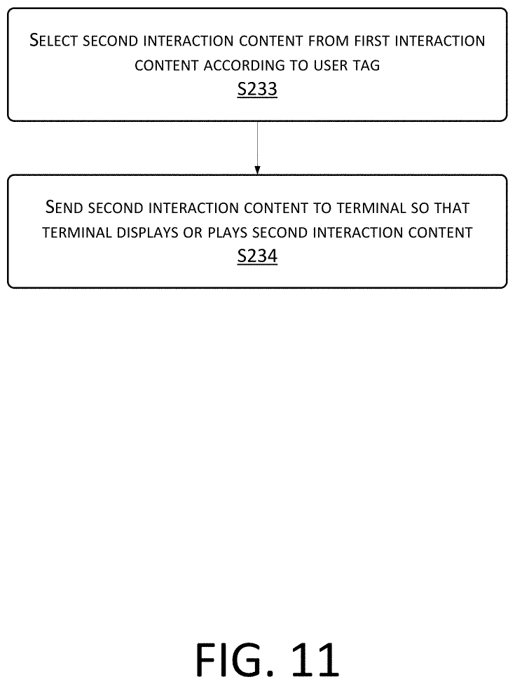

FIG. 11 is a flowchart of step S23 according to an example embodiment of the present disclosure. As shown in FIG. 11, in an example implementation, step S23 may further include the following steps.

In step S233, a second interaction content is selected from the first interaction content according to the user tag.

The server may acquire user tags by searching for user data, and select the second interaction content from the first interaction content according to the user tags. Specifically, for the selecting a second interaction content from the first interaction content according to the user tag, reference may be made to step S123.

In step S234, the second interaction content is sent to the terminal so that the terminal displays or plays the second interaction content.

The server may send the second interaction content to the terminal so that the terminal displays and/or plays the second interaction content.

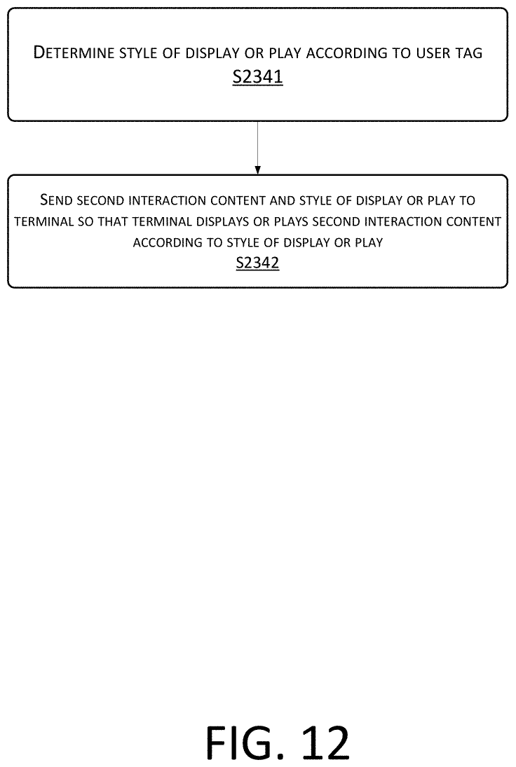

FIG. 12 is a flowchart of step S234 according to an example embodiment of the present disclosure. As shown in FIG. 12, in an example implementation, step S234 may include the following steps.

In step S2341, the style of the display or play is determined according to the user tag.

In step S2342, the second interaction content and the style of the display or play are sent to the terminal so that the terminal displays and/or plays the second interaction content according to the style of the display and/or play.

The server may determine the style of the display and/or play according to the user tags, and send the second interaction content and the style of the display and/or play to the terminal, so that the terminal displays and/or plays the second interaction content according to the style of the display and/or play.

In one example, the user may watch a video at the terminal. When the terminal opens the video, an interaction assistant may pop up a dialog text “Do you want interaction?”. If the user wants interaction, he/she may reply in voice or clicks for confirmation. The interaction assistant may continue to pop up a dialog text “Do you need to set an interaction triggering event? After setting, you may interact as you wish”. If the user determines that setting is needed, the terminal may send information requesting an interaction triggering event setting interface to the server. The server may return the interaction triggering event setting interface, and the terminal displays the received interaction triggering event setting interface. The user may select interaction triggering event options in the interaction triggering event setting interface. For example, if the user selects happy in the user state and play to a preset video time point, the terminal may determine that an interaction triggering event set by the user is the user being happy and play to the preset video time point. Moreover, when the interaction triggering event set by the user includes the user state, the terminal may start a camera to monitor the user.

For example, the video clicked and viewed by the user is a television series set in the Qing dynasty. During the video play, the terminal detects the preset video time point by monitoring the play progress of the video, and at this time, the video picture includes the queen and some imperial concubineses are in a war of words. The terminal may send to the server a request indicating that the interaction triggering event detected by the terminal during the video play is play to the preset video time point. After receiving the request, the server may find an identifier of the preset video time point, and according to the identifier of the preset video time point, find a first interaction content matching the interaction triggering event as preset “The queen is XX”, “The costume of a queen in the Qing Dynasty is composed of a court crown, a court robe, a court jacket, a court skirt, court beads, and the like. The court crown is made of sable for use in winter and is made of blue velvet for use in summer, adorned with a red hat curtain”, “Young Mistress, the plot is particularly thrilling here, right? Which character do you like?”.

The server may determine that the first interaction content matching the interaction triggering event is “The queen is XX”, “The costume of a queen in the Qing Dynasty is composed of a court crown, a court robe, a court jacket, a court skirt, court beads, and the like. The court crown is made of sable for use in winter and is made of blue velvet for use in summer, adorned with a red hat curtain”, “Young Mistress, the plot is particularly thrilling here, right? Which character do you like?” The server may also obtain user tags, which include hobby costumes, history expert, and fan of cute styles. The server may filter out the queen's introduction “The queen is XX” in the first interaction content because the user should be familiar with the history, and the recommendation is unnecessary. The second interaction content selected by the server from the first interaction content is: “The costume of a queen in the Qing Dynasty is composed of a court crown, a court robe, a court jacket, a court skirt, court beads, and the like. The court crown is made of sable for use in winter and is made of blue velvet for use in summer, adorned with a red hat curtain” and “Young Mistress, the plot is particularly thrilling here, right? Which character do you like?”.

The server may send the second interaction content to the terminal, and the terminal may display or play the second interaction content. For example, the second interaction content may be displayed on a cute pattern according to the “fan of cute styles” in the user tags.

The user may choose to reply or ignore the second interaction content. During the process of the user continuing to watch the video, if the terminal detects that the user is laughing, it may be determined that an interaction triggering event, i.e., the user feeling happy, is detected. The terminal may send a request to the server, and the request indicates that the terminal detects that the interaction triggering event is the user feeling happy. The server may find that the first interaction content matching the interaction triggering event as preset is a smiling face, and “Very happy, aren't you? Would you like to share it?”. The server may send the first interaction content to the terminal, and after receiving the first interaction content, the terminal may display or play the first interaction content: a smiling face, and “Very happy, aren't you? Would you like to share it?”.

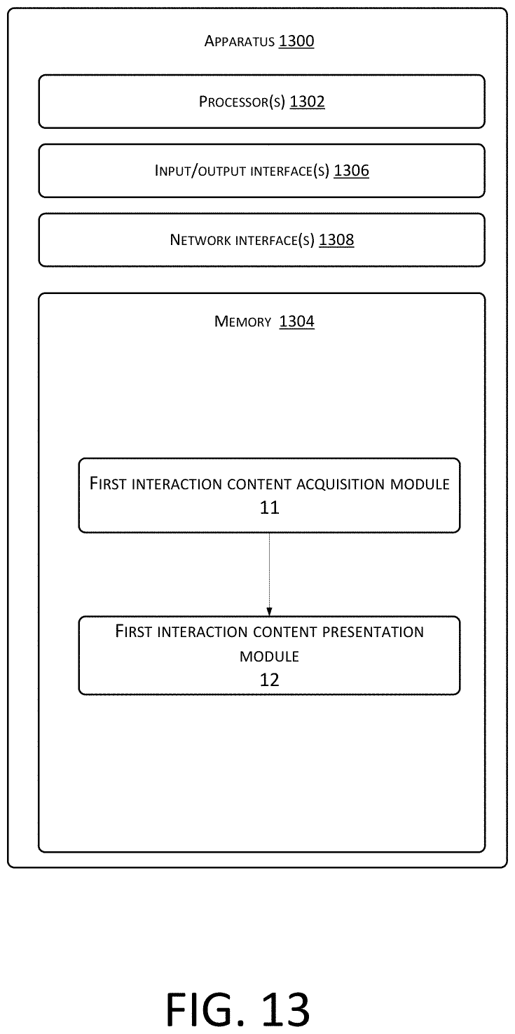

FIG. 13 is a block diagram of a video interaction apparatus according to an example embodiment of the present disclosure. The apparatus may be applicable to a terminal.

As shown in FIG. 13, an apparatus 1300 includes one or more processor(s) 1302 or data processing unit(s) and memory 1304. The apparatus 1300 may further include one or more input/output interface(s) 1306 and one or more network interface(s) 1308. The memory 1304 is an example of computer readable medium or media.

The computer readable medium includes non-volatile and volatile media as well as movable and non-movable media, and may store information by means of any method or technology. The information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

The memory 1304 may store therein a plurality of modules or units including:

a first interaction content acquisition module 11 configured to obtain a first interaction content matching an interaction triggering event when the interaction triggering event is detected during play of a video; and

a first interaction content presentation module 12 configured to display and/or play the first interaction content.

When the interaction triggering event is detected during play of the video, the first interaction content matching the interaction triggering event is obtained, and the first interaction content is displayed or played. The video interaction apparatus according to example embodiments of the present disclosure may interact with the user when the user watches the video, may accompany the user to watch the video, and may timely answer the user's questions, thereby greatly improving the user's experience in watching the video.

In an example implementation, the interaction triggering event may include one or more of the following: a user state, a user input, play to a preset video time point, and play to a video content matching a user tag.

In an example implementation, the first interaction content may include one or more of the following: a text, an audio, a video, an animated picture, and a picture.

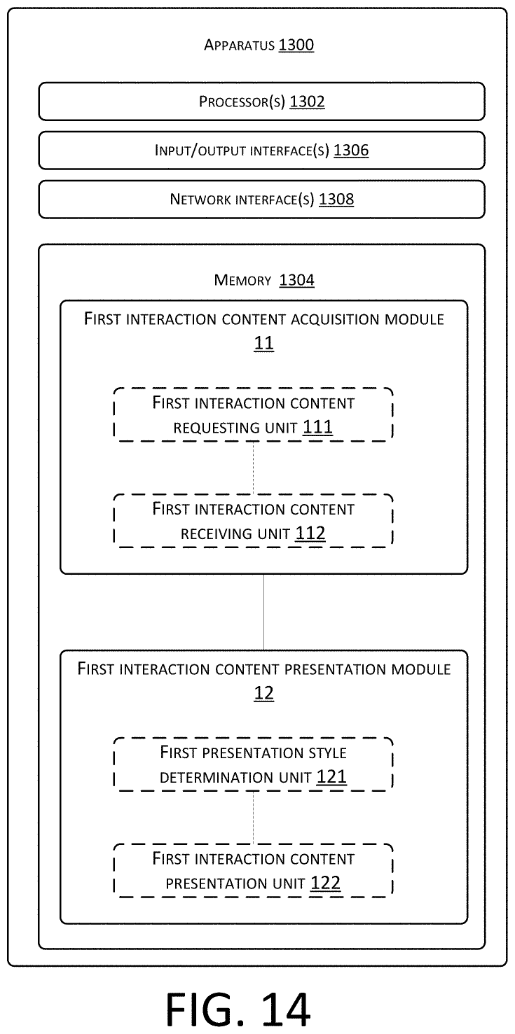

FIG. 14 is a block diagram of a video interaction apparatus according to an example embodiment of the present disclosure. As shown in FIG. 14, in an example implementation, the first interaction content acquisition module 11 may include:

a first interaction content requesting unit 111 configured to send a request indicating the interaction triggering event to a server when the interaction triggering event is detected; and

a first interaction content receiving unit 112 configured to receive the first interaction content matching the interaction triggering event from the server.

As shown in FIG. 14, in an example implementation, the first interaction content presentation module 12 may include:

a first presentation style determination unit 121 configured to determine a style of the display and/or play according to the user tag; and

a first interaction content presentation unit 122 configured to display or play the first interaction content according to the determined style of the display and/or play.

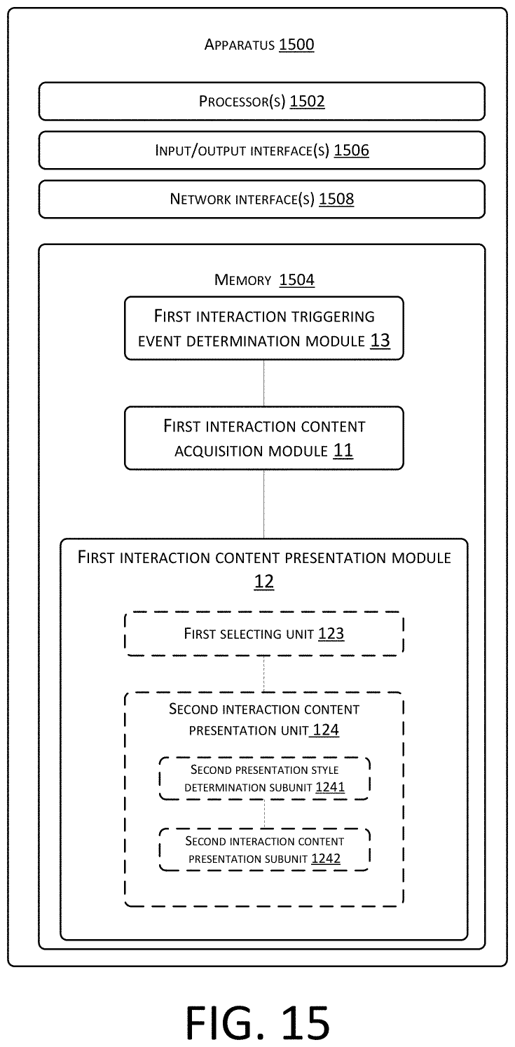

FIG. 15 is a block diagram of a video interaction apparatus according to an example embodiment of the present disclosure. As shown in FIG. 15, an apparatus 1500 includes one or more processor(s) 1502 or data processing unit(s) and memory 1504. The apparatus 1500 may further include one or more input/output interface(s) 1506 and one or more network interface(s) 1508. The memory 1504 is an example of computer readable medium or media.

The memory 1504 may store therein a plurality of modules or units including:

a first interaction content acquisition module 11 configured to obtain a first interaction content matching an interaction triggering event when the interaction triggering event is detected during play of a video;

a first interaction content presentation module 12 configured to display and/or play the first interaction content; and

a first interaction triggering event determination module 13 configured to determine the interaction triggering event according to settings of the user.

As shown in FIG. 15, in an example implementation, the first interaction content presentation module 12 may further include:

a first selecting unit 123 configured to select a second interaction content from the first interaction content according to the user tag; and

a second interaction content presentation unit 124 configured to display and/or play the second interaction content.

As shown in FIG. 15, in an example implementation, the second interaction content presentation unit 124 may include:

a second presentation style determination sub-unit 1241 configured to determine a style of the display and/or play according to the user tag; and

a second interaction content presentation sub-unit 1242 configured to display and/or play the second interaction content according to the determined style of the display or play.

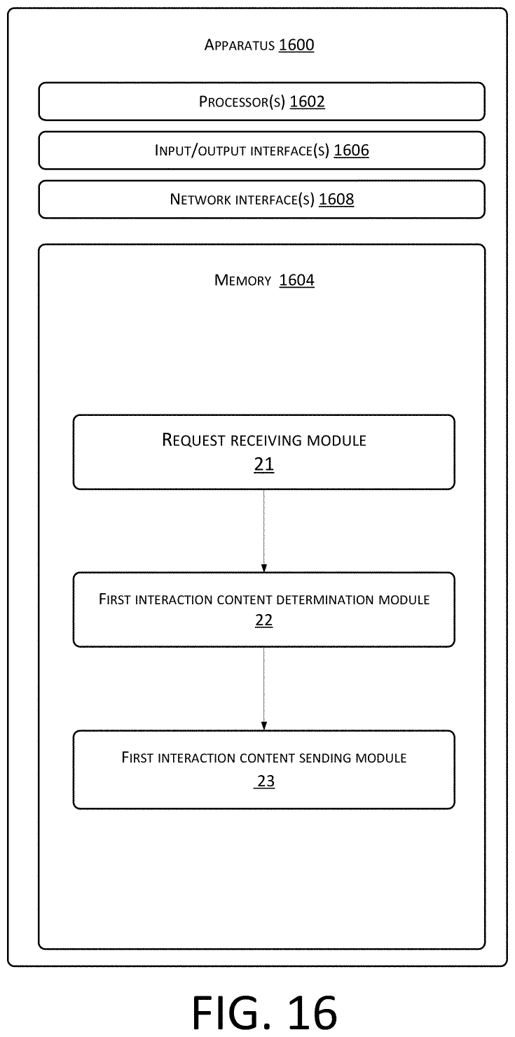

FIG. 16 is a block diagram of a video interaction apparatus according to an example embodiment of the present disclosure. The apparatus may be applicable to a server.

As shown in FIG. 16, an apparatus 1600 includes one or more processor(s) 1602 or data processing unit(s) and memory 1604. The apparatus 1600 may further include one or more input/output interface(s) 1606 and one or more network interface(s) 1608. The memory 1504 is an example of computer readable medium or media.

The memory 1604 may store therein a plurality of modules or units including:

a request receiving module 21 configured to receive a request sent by a terminal, the request indicating an interaction triggering event detected by the terminal during play of a video;

a first interaction content determination module 22 configured to determine the first interaction content matching the interaction triggering event; and

a first interaction content sending module 23 configured to send the first interaction content to the terminal so that the terminal displays and/or plays the first interaction content.

By receiving the request, the terminal is instructed to determine the first interaction content matching the interaction triggering event when the interaction triggering event is detected during play of the video, and send the first interaction content to the terminal so that the terminal displays or plays the first interaction content. The video interaction apparatus according to example embodiments of the present disclosure may interact with the user when the user watches the video, may accompany the user to watch the video, and may timely answer the user's questions, thereby greatly improving the user's experience in watching the video.

In an example implementation, the interaction triggering event may include one or more of the following: a user state, a user input, play to a preset video time point, and play to a video content matching a user tag.

In an example implementation, the first interaction content may include one or more of the following: a text, an audio, a video, an animated picture, and a picture.

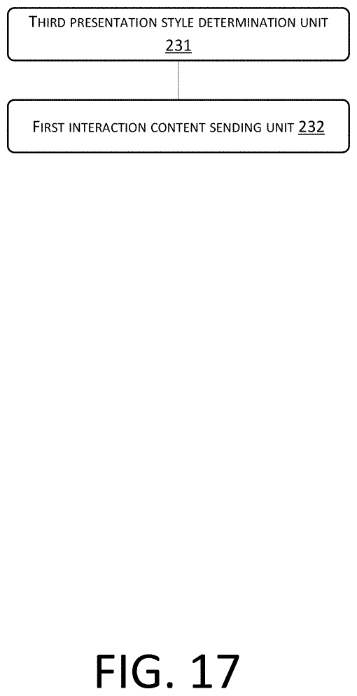

FIG. 17 is a block diagram of a first interaction content sending module 23 according to an example embodiment of the present disclosure. The first interaction content sending module 23 may include:

a third presentation style determination unit 231 configured to determine a style of the display and/or play according to the user tag; and

a first interaction content sending unit 232 configured to send the first interaction content and the style of the display and/or play to the terminal so that the terminal displays and/or plays the first interaction content according to the style of the display and/or play.

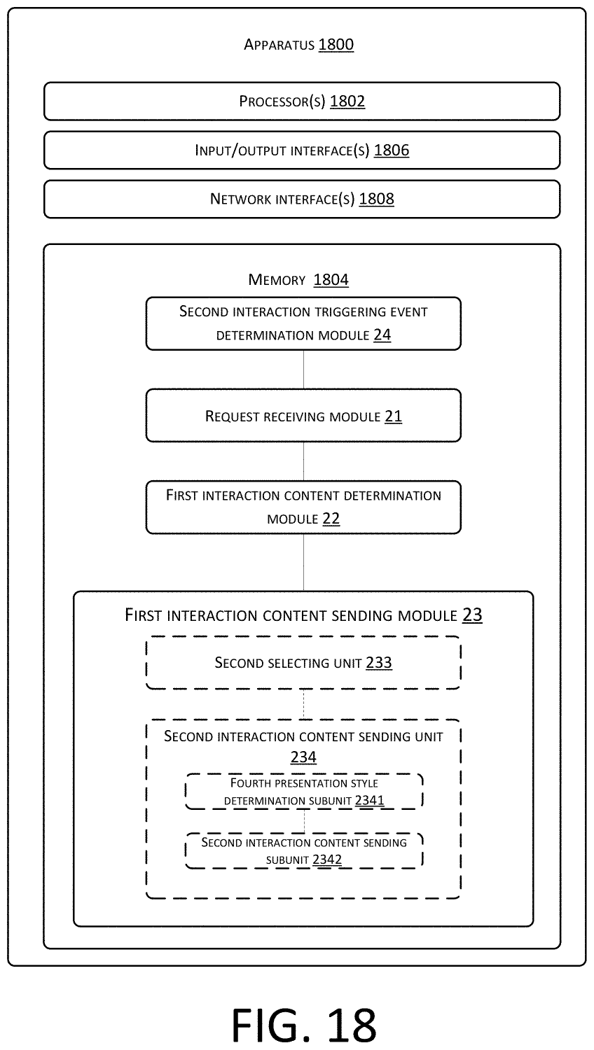

FIG. 18 is a block diagram of a video interaction apparatus according to an example embodiment of the present disclosure.

As shown in FIG. 18, an apparatus 1800 includes one or more processor(s) 1802 or data processing unit(s) and memory 1804. The apparatus 1800 may further include one or more input/output interface(s) 1806 and one or more network interface(s) 1808. The memory 1804 is an example of computer readable medium or media.

The memory 1804 may store therein a plurality of modules or units including:

a request receiving module 21 configured to receive a request sent by a terminal, the request indicating an interaction triggering event detected by the terminal during play of a video;

a first interaction content determination module 22 configured to determine the first interaction content matching the interaction triggering event;

a first interaction content sending module 23 configured to send the first interaction content to the terminal so that the terminal displays and/or plays the first interaction content; and

a second interaction triggering event determination module 24 configured to determine the interaction triggering event according to settings of the user.

As shown in FIG. 18, in an example implementation, the first interaction content sending module 23 may further include:

a second selecting unit 233 configured to select a second interaction content from the first interaction content according to the user tag; and

a second interaction content sending unit 234 configured to send the second interaction content to the terminal so that the terminal displays and/or plays the second interaction content.

As shown in FIG. 18, in an example implementation, the second interaction content sending unit 234 may include:

a fourth presentation style determination sub-unit 2341 configured to determine a style of the display and/or play according to the user tag; and

a second interaction content sending sub-unit 2342 configured to send the second interaction content and the style of the display or play to the terminal so that the terminal displays and/or plays the second interaction content according to the style of the display and/or play.

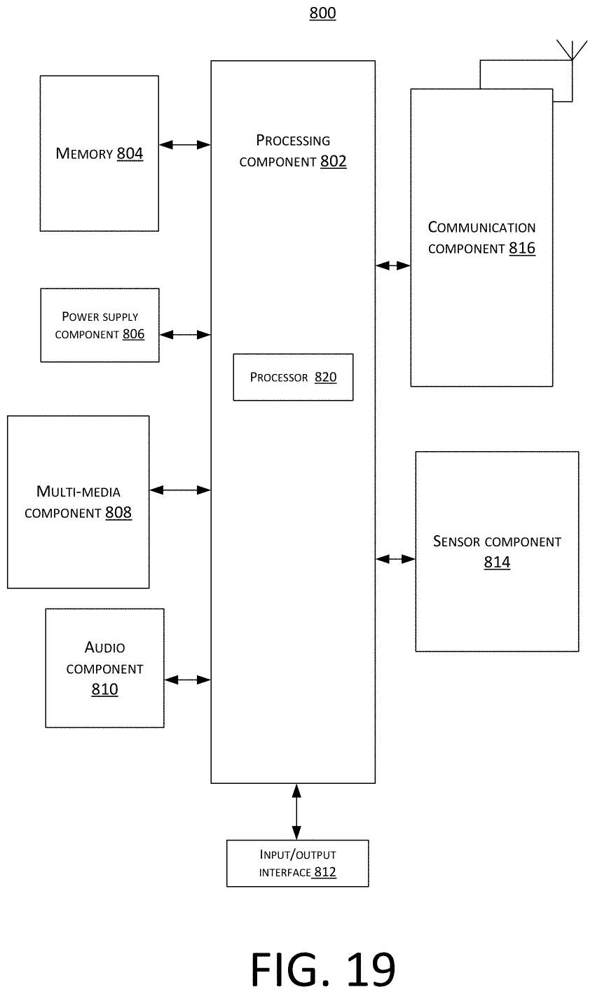

FIG. 19 is a block diagram of a video interaction apparatus 800 according to an example embodiment of the present disclosure. For example, the apparatus 800 may be a mobile phone, a computer, a digital broadcasting terminal, a message transceiver, a game console, a tablet device, medical equipment, fitness equipment, a personal digital assistant, and the like.

Referring to FIG. 19, the apparatus 800 may include one or more of the following components: a processing component 802, a memory 804, a power supply component 806, a multi-media component 808, an audio component 810, an input/output (I/O) interface 812, a sensor component 814, and a communication component 816.

The processing component 802 generally controls overall operation of the apparatus 800, e.g., operations associated with displaying, phone calls, data communication, camera operations, and record operations. The processing component 802 may include one or more processors 820 to execute instructions, thus implementing all or a part of steps in the foregoing method. Moreover, the processing component 802 may include one or more modules, thus facilitating interaction between the processing component 802 and other components. For example, the processing component 802 may include a multimedia module, thus facilitating interaction between the multimedia component 808 and the processing component 802.

The memory 804 is configured to store various types of data to support operations in the apparatus 800. Examples of these types of data include instructions of any application programs or instructions operated in the apparatus 800, contact data, phone book data, messages, pictures, videos, and the like. The memory 804 may be implemented by any type of volatile or non-volatile memory device or a combination thereof, such as a static random-access memory (SRAM), an electrically erasable programmable read-only memory (EEPROM), an erasable programmable read-only memory (EPROM), a programmable read-only memory (PROM), a magnetic memory, a flash memory, a magnetic disk, or a compact disc.

The power supply component 806 provides power for various components of the apparatus 800. The power supply component 806 may include a power supply management system, one or more power supplies, and other components associated with power generation, management, and distribution for the apparatus 800.

The multimedia component 808 includes a screen for providing an output interface between the apparatus 800 and a user. In some example embodiments, the screen may include a liquid crystal display (LCD) and a touch panel (TP). If the screen includes the TP, the screen may be implemented as a touch screen to receive an input signal from the user. The TP includes one or more touch sensors to sense touches, slides, and gestures on the touch panel. The touch sensor may not only sense boundaries of a touching or sliding movement, but also detect duration and pressure associated with the touching or sliding operation. In some example embodiments, the multimedia component 808 includes a front camera and/or a rear camera. When the apparatus 800 is in an operating mode, e.g., in a camera mode or a video mode, the front camera and/or the rear camera may receive multimedia data from the external. Each of the front camera and the rear camera may be a fixed optical lens system or have focusing and optical zooming functions.

The audio component 810 is configured to output and/or input audio signals. For example, the audio component 810 includes a microphone (MIC). When the apparatus 800 is in the operating mode, e.g., in a call mode, a record mode, and a voice recognition mode, the MIC is configured to receiver external audio signals. The received audio signals may be further stored in the memory 804 or sent through the communication component 816. In some example embodiments, the audio component 810 further includes a loudspeaker configured to output audio signals.

The I/O interface 812 provides an interface between the processing component 802 and a peripheral interface module. The peripheral interface module may be a keyboard, a click wheel, buttons, or the like. The buttons may include, but are not limited to, a homepage button, a volume button, a start button, and a lock button.

The sensor component 814 includes one or more sensors configured to provide state estimation in various aspects for the apparatus 800. For example, the sensor component 814 may detect an on/off state of the apparatus 800, and relative positioning of components such as a display and a keypad of the apparatus 800. The sensor component 814 may further detect a position change in the apparatus 800 or a component of the apparatus 800, existence or absence of contact of the user with the apparatus 800, the orientation and acceleration/deceleration of the apparatus 800, or a temperature change in the apparatus 800. The sensor component 814 may include a proximity sensor configured to detect existence of a nearby object without any physical contact. The sensor component 814 may further include an optical sensor, such as a CMOS or CCD image sensor, configured to be used in an imaging application. In some example embodiments, the sensor component 814 may further include an acceleration sensor, a gyroscope sensor, a magnetic sensor, a pressure sensor or a temperature sensor.

The communication component 816 is configured to facilitate wired or wireless communication between the apparatus 800 and other devices. The apparatus 800 may be connected to a wireless network based on a communication standard, such as WiFi, 2G, 3G, or a combination thereof. In an example embodiment, the communication component 816 receives broadcast signals from an external broadcast management system or broadcasts relevant information through a broadcast channel. In an example embodiment, the communication component 816 further includes a near-field communication (NFC) module to promote short-range communication. For example, the NFC module may be implemented based on the radio frequency identification (RFID) technology, the infrared data association (IrDA) technology, the ultra-wide band (UWB) technology, the Bluetooth (BT) technology, and other technologies.

In an example embodiment, the apparatus 800 may be implemented by one or more application specific Integrated circuits (ASICs), digital signal processors (DSP), digital signal processing devices (DSPD), programmable logic devices (PLD), field programmable gate arrays (FPGA), controllers, microcontrollers, microprocessors, or other electronic elements, for performing the foregoing method.

In an example embodiment, a non-volatile computer readable medium is further provided, for example, the memory 804 including computer-readable instructions executable by a processor 820 of the apparatus 800 to implement the foregoing method.

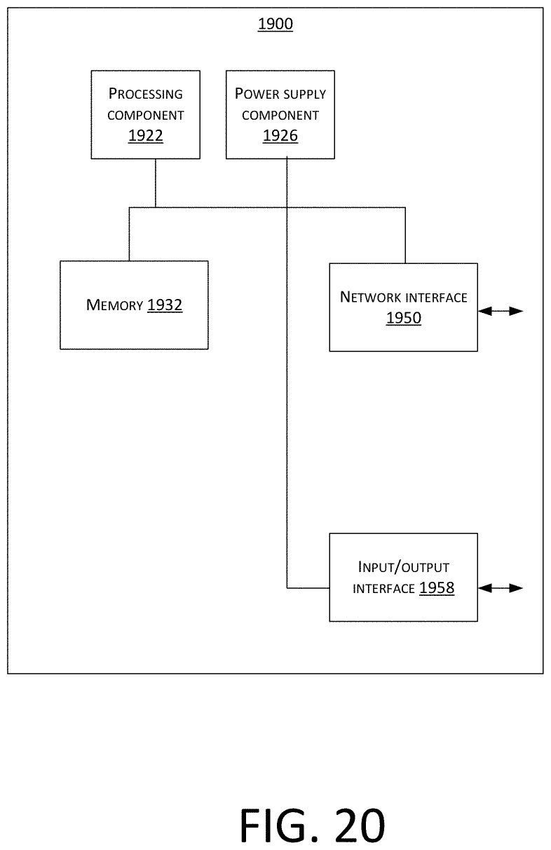

FIG. 20 is a block diagram of a video interaction apparatus 1900 according to an example embodiment of the present disclosure. For example, the apparatus 1900 may be provided as a server. Referring to FIG. 20, the apparatus 1900 includes a processing component 1922, and further includes one or more processors, and memory resources represented by a memory 1932 configured to store instructions, e.g., application programs, executable by the processing component 1922. The application programs stored in the memory 1932 may include one or more modules each corresponding to a group of instructions. Moreover, the processing component 1922 is configured to execute the instructions to perform the foregoing method.

The apparatus 1900 may further include a power supply component 1926 configured to manage power supply for the apparatus 1900, a wired or wireless network interface 1950 configured to connect the apparatus 1900 to a network, and an input/output (I/O) interface 1958. The apparatus 1900 may be operated based on an operating system stored in the memory 1932, such as Windows Server™, Mac OS X™, Unix™, Linux™, FreeBSD™, or the like.

In an example embodiment, a non-volatile computer readable medium is further provided, for example, the memory 1932 including computer-readable instructions executable by the processing component 1922 of the apparatus 1900 to implement the foregoing method.

The present disclosure may be a system, a method and/or a computer program product. The computer program product may include a computer readable medium that contains computer-readable instructions enabling the processor to implement various aspects of the present disclosure.

The computer readable medium may be a physical device capable of retaining and storing instructions used by an instruction executing device. The computer readable medium may be, for example, but is not limited to, an electrical storage device, a magnetic storage device, an optical storage device, an electromagnetic storage device, a semiconductor storage device, or any suitable combination of the above. More specific examples (a non-exhaustive list) of the computer readable medium include: a portable computer disk, a hard disk, a random access memory (RAM), a read-only memory (ROM), an erasable programmable read-only memory (EPROM or a flash memory), a static random access memory (SRAM), a portable compact disk read-only memory (CD-ROM), a digital versatile disk (DVD), a memory stick, a floppy disk, a mechanical coding device such as a punched card or protrusions in a groove on which instructions are stored, and any suitable combination of the above. The computer readable medium used here is not explained as a transitory signal itself, such as radio waves or other electromagnetic waves propagated freely, electromagnetic waves propagated through waveguides or other transmission media (e.g., light pulses propagated through fiber-optic cables), or electrical signals transmitted over wires.

The computer-readable instructions described here may be downloaded from the computer readable medium to various computing/processing devices or downloaded to external computers or external storage devices over a network such as the Internet, a local area network, a wide area network and/or a wireless network. The network may include copper transmission cables, fiber optic transmission, wireless transmission, routers, firewalls, switches, gateway computers and/or edge servers. A network adapter card or a network interface in each computing/processing device receives computer-readable instructions from the network and forwards the computer-readable instructions for storage in the computer readable medium in each computing/processing device.

The computer-readable instructions for performing operations of the present disclosure may be assembly instructions, instruction set architecture (ISA) instructions, machine instructions, machine related instructions, microcodes, firmware instructions, state setting data, or source codes or object codes written in any combination of one or more programming languages including object-oriented programming languages, such as Smalltalk, C++, as well as conventional procedural programming language such as the “C” language or similar programming languages. The computer-readable instructions may be executed completely on a user's computer, partially on the user's computer, as a separate software package, partially on the user's computer and partially on a remote computer, or completely on the remote computer or server. In the case of involving the remote computer, the remote computer may be connected to the user's computer over any kind of network including a local area network (LAN) or a wide area network (WAN), or it may be connected to an external computer (for example, connected over the Internet using an Internet service provider). In some example embodiments, state information of the computer-readable instructions is used to customize an electronic circuit, such as a programmable logic circuit, a field programmable gate array (FPGA) or a programmable logic array (PLA). The electronic circuit may execute the computer-readable instructions to implement all aspects of the present disclosure.

Various aspects of the present disclosure are described with reference to flowcharts and/or block diagrams of the method, the apparatus (system) and the computer program product according to the example embodiments of the present disclosure. It should be understood that a computer program instruction may be used to implement each block in the flowcharts and/or block diagrams and a combination of blocks in the flowcharts and/or block diagrams.

The computer-readable instructions may be provided to a general-purpose computer, a special-purpose computer, or a processor of another programmable data processing apparatus to generate a machine, such that the computer or the processor of another programmable data processing apparatus executes the instructions to generate an apparatus configured to implement functions/actions designated in one or more blocks in the flowcharts and/or block diagrams. The computer-readable instructions may also be stored in a computer readable memory that may guide the computer or another programmable data processing apparatus and/or other devices to work in a specific manner, such that the computer readable medium storing the instructions includes an article of manufacture including instructions for implementing various aspects of functions/actions specified by one or more blocks in the flowcharts and/or block diagrams.

The computer-readable instructions may also be loaded to the computer or another programmable data processing apparatus or other devices, such that a series of operation steps are executed on the computer or another programmable apparatus or other devices to generate a computer implemented processing, and therefore, the instructions executed in the computer or another programmable apparatus or other devices implement functions/actions specified by one or more blocks in the flowcharts and/or block diagrams.

The flowcharts and block diagrams in the accompanying drawings display possibly implemented system architecture, functions and operations of the system, method and computer program product according to various example embodiments of the present disclosure. In this point, each block in the flowcharts or block diagrams may represent a module, a program segment, or a part of an instruction. The module, the program segment or the part of the instruction includes one or more executable instructions for implementing specified logical functions. In some alternative implementations, functions illustrated in the blocks may occur in an order different from that as illustrated in the accompanying drawing. For example, two successive blocks may be performed basically in parallel, and they may be performed in an opposite order sometimes, depending on involved functions. It also should be noted that each block in the block diagrams and/or flowcharts, and a combination of blocks in the block diagrams and/or flowcharts may be implemented using a dedicated hardware-based system for executing specified functions or actions, or may be implemented using a combination of dedicated hardware and computer instructions.

Various example embodiments of the present disclosure have been described above, and the foregoing illustration is exemplary rather than exhaustive, and the present disclosure is not limited to the disclosed example embodiments. Many modifications and variations are obvious for those of ordinary skill in the art without departing from the scope and spirit of the illustrated example embodiments. The terms selected in this text are aimed to best explain principles of the example embodiments, actual applications, or technical improvements to technologies in the market, or enable other persons of ordinary skill in the art to understand the example embodiments disclosed in this text.

The present disclosure may further be understood with clauses as follows.

Clause 1. A video interaction method, wherein the method is applied to a terminal and comprises:

obtaining a first interaction content matching an interaction triggering event when the interaction triggering event is detected during play of a video; and

displaying and/or playing the first interaction content.

Clause 2. The method of clause 1, wherein the interaction triggering event comprises one or more of the following: a user state, a user input, play to a preset video time point, and play to a video content matching a user tag.

Clause 3. The method of clause 1, wherein obtaining a first interaction content matching an interaction triggering event when the interaction triggering event is detected comprises:

sending a request indicating the interaction triggering event to a server when the interaction triggering event is detected; and

receiving the first interaction content matching the interaction triggering event from the server.

Clause 4. The method of clause 1, further comprising:

determining the interaction triggering event according to settings of the user.

Clause 5. The method of clause 1, wherein displaying and/or playing the first interaction content comprises:

selecting a second interaction content from the first interaction content according to the user tag; and

displaying and/or playing the second interaction content.

Clause 6. The method of clause 1, wherein the first interaction content comprises one or more of the following: a text, an audio, a video, an animated picture, and a picture.

Clause 7. The method of clause 1, wherein displaying and/or playing the first interaction content comprises:

determining a style of the display and/or play according to the user tag; and

displaying or playing the first interaction content according to the determined style of the display and/or play.

Clause 8. The method of clause 5, wherein displaying and/or playing the second interaction content comprises:

determining a style of the display and/or play according to the user tag; and

displaying and/or playing the second interaction content according to the determined style of the display or play.

Clause 9. A video interaction method, wherein the method is applied to a server and comprises:

receiving a request sent by a terminal, the request indicating an interaction triggering event detected by the terminal during play of a video;

determining the first interaction content matching the interaction triggering event; and

sending the first interaction content to the terminal so that the terminal displays and/or plays the first interaction content.

Clause 10. The method of clause 9, wherein the interaction triggering event comprises one or more of the following: a user state, a user input, play to a preset video time point, and play to a video content matching a user tag.

Clause 11. The method of clause 9, further comprising:

determining the interaction triggering event according to settings of the user.

Clause 12. The method of clause 9, wherein sending the first interaction content to the terminal so that the terminal displays and/or plays the first interaction content comprises:

selecting a second interaction content from the first interaction content according to the user tag; and

sending the second interaction content to the terminal so that the terminal displays and/or plays the second interaction content.

Clause 13. The method of clause 9, wherein the first interaction content comprises one or more of the following: a text, an audio, a video, an animated picture, and a picture.

Clause 14. The method of clause 9, wherein sending the first interaction content to the terminal so that the terminal displays and/or plays the first interaction content comprises:

determining a style of the display and/or play according to the user tag; and

sending the first interaction content and the style of the display and/or play to the terminal so that the terminal displays and/or plays the first interaction content according to the style of the display and/or play.

Clause 15. The method of clause 12, wherein sending the second interaction content to the terminal so that the terminal displays and/or plays the second interaction content comprises:

determining a style of the display and/or play according to the user tag; and

sending the second interaction content and the style of the display or play to the terminal so that the terminal displays and/or plays the second interaction content according to the style of the display and/or play.

Clause 16. A video interaction apparatus, comprising:

a first interaction content acquisition module configured to obtain a first interaction content matching an interaction triggering event when the interaction triggering event is detected during play of a video; and

a first interaction content presentation module configured to display and/or play the first interaction content.

Clause 17. The apparatus of clause 16, wherein the interaction triggering event comprises one or more of the following: a user state, a user input, play to a preset video time point, and play to a video content matching a user tag.

Clause 18. The apparatus of clause 16, wherein the first interaction content acquisition module comprises:

a first interaction content requesting unit configured to send a request indicating the interaction triggering event to a server when the interaction triggering event is detected; and

a first interaction content receiving unit configured to receive the first interaction content matching the interaction triggering event from the server.

Clause 19. The apparatus of clause 16, further comprising:

a first interaction triggering event determination module configured to determine the interaction triggering event according to settings of the user.

Clause 20. The apparatus of clause 16, wherein the first interaction content presentation module comprises:

a first selecting unit configured to select a second interaction content from the first interaction content according to the user tag; and

a second interaction content presentation unit configured to display and/or play the second interaction content.

Clause 21. The apparatus of clause 16, wherein the first interaction content comprises one or more of the following: a text, an audio, a video, an animated picture, and a picture.

Clause 22. The apparatus of clause 16, wherein the first interaction content presentation module comprises:

a first presentation style determination unit configured to determine a style of the display and/or play according to the user tag; and

a first interaction content presentation unit configured to display or play the first interaction content according to the determined style of the display and/or play.

Clause 23. The apparatus of clause 20, wherein the second interaction content presentation unit comprises:

a second presentation style determination sub-unit configured to determine a style of the display and/or play according to the user tag; and

a second interaction content presentation sub-unit configured to display and/or play the second interaction content according to the determined style of the display or play.

Clause 24. A video interaction apparatus, comprising:

a request receiving module configured to receive a request sent by a terminal, the request indicating an interaction triggering event detected by the terminal during play of a video;

a first interaction content determination module configured to determine the first interaction content matching the interaction triggering event; and

a first interaction content sending module configured to send the first interaction content to the terminal so that the terminal displays and/or plays the first interaction content.

Clause 25. The apparatus of clause 24, wherein the interaction triggering event comprises one or more of the following: a user state, a user input, play to a preset video time point, and play to a video content matching a user tag.

Clause 26. The apparatus of clause 24, further comprising:

a second interaction triggering event determination module configured to determine the interaction triggering event according to settings of the user.

Clause 27. The apparatus of clause 24, wherein the first interaction content sending module comprises:

a second selecting unit configured to select a second interaction content from the first interaction content according to the user tag; and

a second interaction content sending unit configured to send the second interaction content to the terminal so that the terminal displays and/or plays the second interaction content.

Clause 28. The apparatus of clause 24, wherein the first interaction content comprises one or more of the following: a text, an audio, a video, an animated picture, and a picture.

Clause 29. The apparatus of clause 24, wherein the first interaction content sending module comprises:

a third presentation style determination unit configured to determine a style of the display and/or play according to the user tag; and

a first interaction content sending unit configured to send the first interaction content and the style of the display and/or play to the terminal so that the terminal displays and/or plays the first interaction content according to the style of the display and/or play.

Clause 30. The apparatus of clause 27, wherein the second interaction content sending unit comprises:

a fourth presentation style determination sub-unit configured to determine a style of the display and/or play according to the user tag; and

a second interaction content sending sub-unit configured to send the second interaction content and the style of the display or play to the terminal so that the terminal displays and/or plays the second interaction content according to the style of the display and/or play.

Clause 31. A video interaction apparatus, comprising:

a processor; and

a memory configured to store instructions executable by the processor, wherein the processor is configured to perform the method of any one of clauses 1 to 15 when executing the instructions.

Clause 32. A non-volatile computer readable medium, having computer-readable instructions stored thereon, wherein when executed by a processor, the computer-readable instructions implement the method according to any one of clauses 1 to 15.

What is claimed is:

1. A method comprising:
detecting an interaction triggering event during play of a video;
obtaining a first interaction content matching the interaction triggering event; and
displaying or playing the first interaction content.

2. The method of claim 1, wherein the interaction triggering event includes a user state.

3. The method of claim 1, wherein the interaction triggering event includes a user input.

4. The method of claim 1, wherein the interaction triggering event includes a preset video time point.

5. The method of claim 1, wherein the interaction triggering event includes a video content matching a user tag.

6. The method of claim 1, wherein the obtaining the first interaction content matching the interaction triggering event includes:
sending a request indicating the interaction triggering event to a server in response to the detecting the interaction triggering event; and
receiving the first interaction content matching the interaction triggering event from the server.

7. The method of claim 1, further comprising:
determining the interaction triggering event according to a setting of a user.

8. The method of claim 1, wherein the displaying or playing the first interaction content includes:
selecting a second interaction content from the first interaction content according to a user tag; and
displaying or playing the second interaction content.

9. The method of claim 8, wherein the displaying or playing the second interaction content includes:
determining a style of the display or play according to the user tag; and
displaying or playing the second interaction content according to the style.

10. The method of claim 1, wherein the first interaction content includes one or more of the following:
a text;
an audio;
a video;
an animated picture; and
a picture.

11. The method of claim 1, wherein the displaying or playing the first interaction content includes:
determining a style of the display or play according to a user tag; and
displaying or playing the first interaction content according to the style.

12. An apparatus comprising:
one or more processors; and
one or more memories storing computer readable instructions that, executable by the one or more processors, cause the one or more processors to perform acts comprising:
receiving a request sent by a terminal, the request indicating an interaction triggering event detected by the terminal during play of a video;
determining a first interaction content matching the interaction triggering event; and
sending the first interaction content to the terminal.

13. The apparatus of claim 12, wherein the interaction triggering event includes one or more of the following:
a user state;
a user input;
a preset video time point; and
a video content matching a user tag.

14. The apparatus of claim 12, wherein the acts further comprise:
determining the interaction triggering event according to a setting of a user.

15. The apparatus of claim 12, wherein the sending the first interaction content to the terminal includes:
selecting a second interaction content from the first interaction content according to a user tag; and
sending the second interaction content to the terminal.

16. The apparatus of claim 15, wherein the sending the second interaction content to the terminal includes:
determining a style of the display or play according to the user tag; and
sending the second interaction content and the style to the terminal so that the terminal displays or plays the second interaction content according to the style.

17. The apparatus of claim 12, wherein the first interaction content includes one or more of the following:
a text;
an audio;
a video;
an animated picture; and
a picture.

18. The apparatus of claim 12, wherein the sending the first interaction content to the terminal includes:
determining a style of the display or play according to a user tag; and
sending the first interaction content and the style of the display or play to the terminal so that the terminal displays or plays the first interaction content according to the style.

19. One or more memories storing computer readable instructions that, executable by one or more processors, cause the one or more processors to perform acts comprising:
detecting an interaction triggering event during play of a video;
obtaining a first interaction content matching the interaction triggering event; and
displaying or playing the first interaction content.

20. The one or more memories of claim 19, wherein the displaying or playing the first interaction content includes:
determining a style of the display or play according to a user tag; and
displaying or playing the first interaction content according to the style.
